(19) United States
(12) Patent Application Publication
(10) Pub. No.: US 2004/0024699 A1
(43) Pub. Date: Feb. 5, 2004

(54) Credit card acceptance system in airplanes

(76) Inventor: Varughese Philip, Roslyn, NY (US)

Correspondence Address: VARUGHESE PHILIP, 192 DOGWOOD ROAD, ROSLYN, NY, 11576, US

(21) Appl. No.: 10/211,853

(22) Filed: Aug. 5, 2002

(51) Int. Cl. G06F 17/60

(52) U.S. Cl. 705/39

(57) ABSTRACT

An airplane having a wireless modem on board that allows passengers to charge the merchandise bought on airplanes to a credit card.

### BACKGROUND OF THE INVENTION

1. Field of the Invention

This invention relates to airplanes and in particular to a system on board an airplane that allows passengers to charge the merchandise bought on an airplane to a credit card.

2. Description of Related Art

Passengers traveling on an airplane that involves long flight time like international flights usually buy merchandise sold on the airplane during the flight time. The passengers frequently carry a limited amount of cash and depend on the use of credit cards to pay for the merchandise. It is desired that a system be provided for credit card payment for the merchandise bought on the airplane.

### SUMMARY OF THE INVENTION

The invention consists of a credit card reader and a wireless modem on board an airplane that allows passengers to charge the merchandise bought on an airplane to a credit card. The card reader is used for reading information stored on a card usually in magnetic strips or chips and also to enter the amount to be charged. The modem provides wireless communications using an antenna.

### BRIEF DESCRIPTION OF THE DRAWINGS

FIG. 1. is a block diagram of the present invention.

FIG. 2. is a block diagram in accordance with the present invention for handling a credit card transaction.

FIG. 3. is a flowchart of the present invention for handling a credit card transaction.

### DETAILED DESCRIPTION OF THE PREFERRED EMBODIMENTS

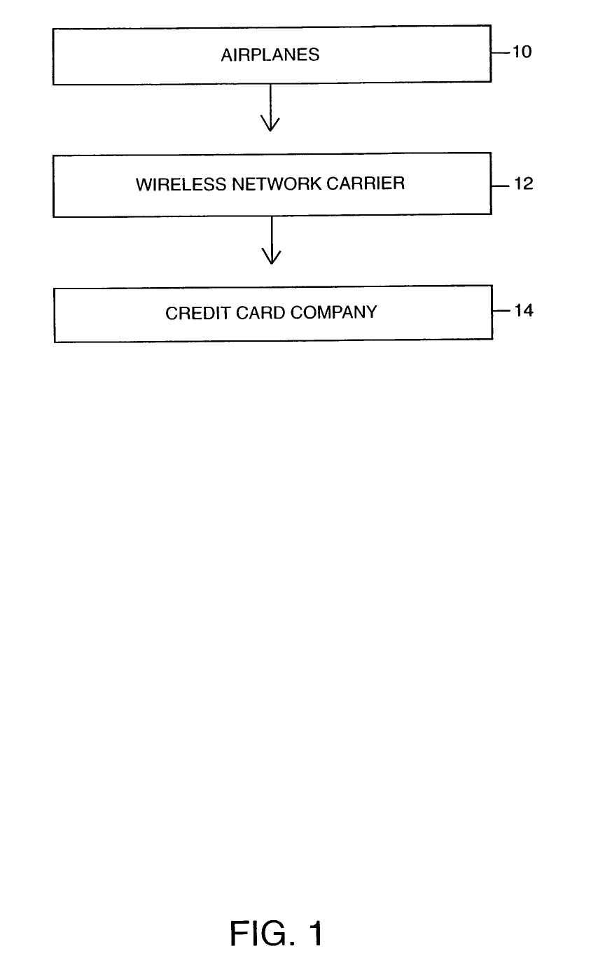

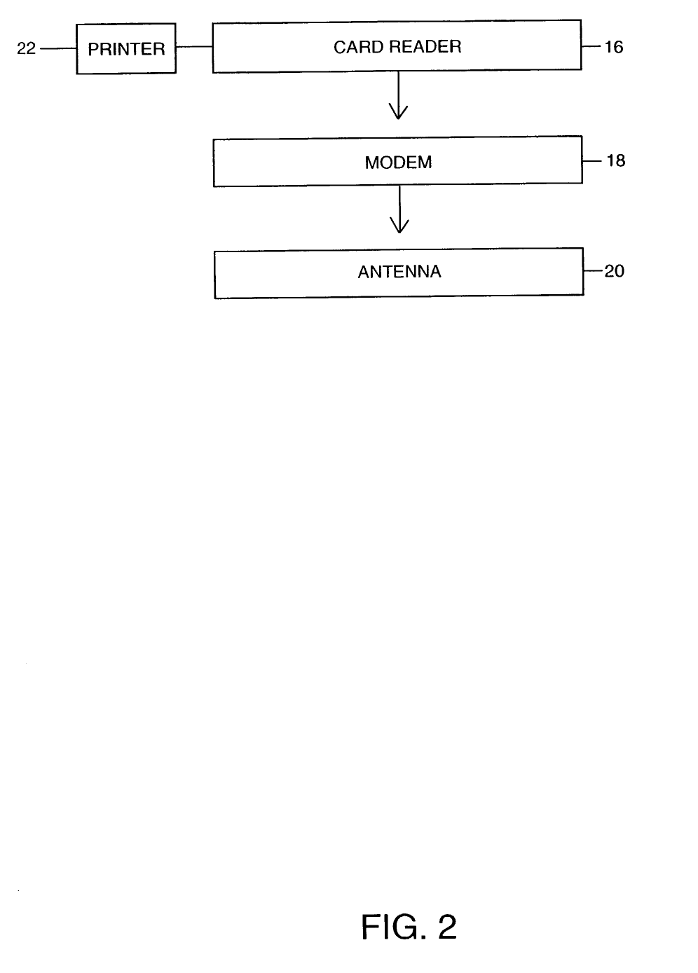

In FIG. 1 Airplane 10 is provided with a modem 18 (shown in FIG. 2) that is connected to an antenna 20.

Modem 18 interfaces and exchanges signals with with a wireless network carrier 12. The wireless network carrier 12 allows the airplane 10 to communicate with the credit card company 14 to facilitate credit card transaction.

As shown in FIG. 2 Airplane 10 is provided with a credit card reader 16. The credit card reader 16 is electrically connected to a modem 18. Modem 18 having a Cellular Digital Packet data (CDPD) be used to transfer the total amount to be charged for credit card company authorization. Modem 18 is connected to an antenna 20. A printer 22 is also electrically connected to the card reader 16.

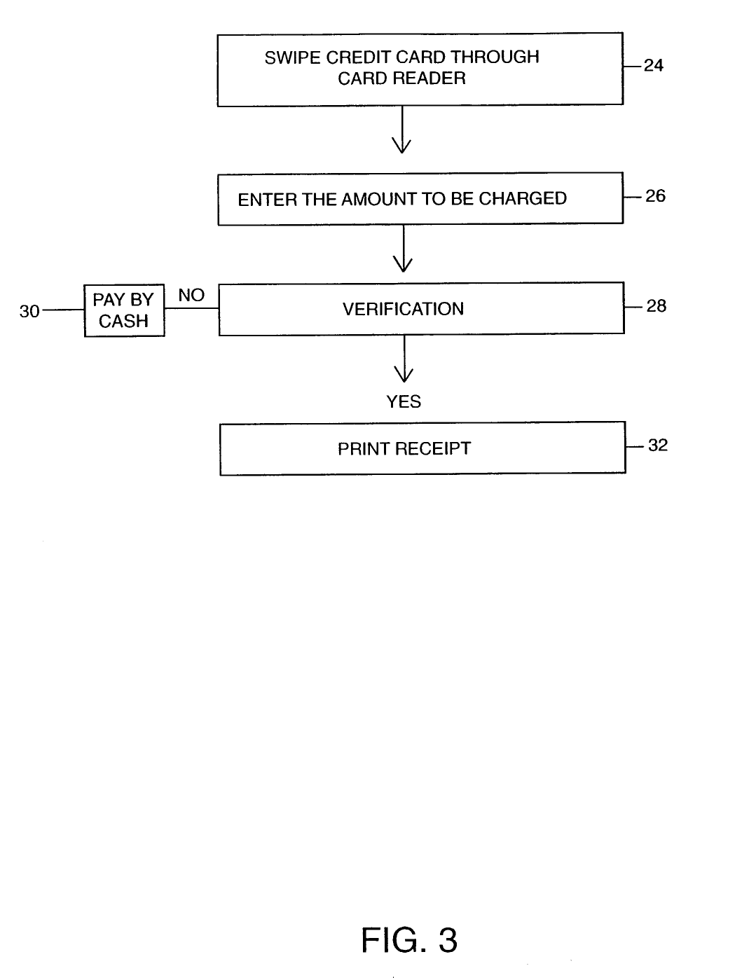

In FIG. 3 the card member authorizes his card to be charged by swiping the card through the card reader, step 24. After swiping the card through the card reader, the amount to be charged is entered on the credit card reader, step 26. Verification process 28 sends necessary information to the credit card company. For verification process a modem 18 with Cellular Digital Packet Data (CDPD) be used to transfer the amount to be charged for credit card company authorization. If verification is failed, the card member is advised to pay by cash, step 30. After verification has been successful, the credit card is charged and a receipt is printed, step 32, showing the authorization number. The card member may then sign the receipt and the transaction is completed.

What is claimed is:

1. A method for accepting a credit card for payment for merchandise sold in an airplane comprising:
a) A credit card reader on board an airplane;
b) A modem for wireless communication electrically connected to a credit card reader and to an antenna for transferring information between the said credit card reader and the credit card company.

2. The method according to claim 1 wherein the said medem is used to wirelessly transfer to the credit card company the amount being charged.

3. The method according to claim 1 wherein the said modem is used to wirelessly receive authorization from the credit card company.

4. The method according to claim 1 further comprising a printer electrically connected to the credit card reader.

5. A method for accepting a credit card for payment for merchandise sold in an airplane comprising the steps of:
a) swiping said credit card through said credit card reader;
b) entering the amount to be charged on said credit card reader;
c) reading information stored on said credit card;
d) searching credit card company database for the credit card number;
e) waiting for authorization from the credit card company for the amount being charged;
f) completing the transaction by charging said credit card;
g) printing a receipt for the amount charged.
